(19) United States
(12) Patent Application Publication
(10) Pub. No.: US 2005/0232457 A1
(43) Pub. Date: Oct. 20, 2005

(54) Speaker-use diaphragm and speaker

(75) Inventors: Satoshi Hachiya, Yamagata (JP); Koji Matsumoto, Yamagata (JP)

Correspondence Address: MORGAN LEWIS & BOCKIUS LLP, 1111 PENNSYLVANIA AVENUE NW, WASHINGTON, DC, 20004, US

(73) Assignees: Pioneer Corporation; Tohoku Pioneer Corporation

(21) Appl. No.: 11/105,569

(22) Filed: Apr. 14, 2005

(30) Foreign Application Priority Data
Apr. 15, 2004 (JP) P 2004-120456

(51) Int. Cl. H04R 25/00

(52) U.S. Cl. 381/426

(57) ABSTRACT

A diaphragm is manufactured by impregnating a woven cloth of e.g. aramid fiber with thermosetting resin and thereafter performing heat-molding so that the woven cloth is molded into a predetermined shape. The woven cloth has a weaving structure with a weaving pattern which partitions a succession of textures of plane-weaving by a predetermined polygonal geometrical pattern.

The present disclosure relates to the subject matter contained in Japanese Patent Application No. 2004-120456 filed on Apr. 15, 2004, which is incorporated herein by reference in its entirety.

### BACKGROUND OF THE INVENTION

1. Field of the Invention

This invention relates to a diaphragm for use in a speaker (hereinafter also referred to a speaker-use diaphragm) and a speaker using the diaphragm.

2. Description of the Related Art

FIG. 1 shows the structure of a speaker in a related art.

A speaker 1 includes a magnetic circuit 3, a frame 5 to the rear of which the magnetic circuit 3 is attached, a cone-shaped diaphragm 9 in which a roll-shaped edge 7 on the outer edge is secured to an edge supporting portion 5a at the front of the frame 5 and a voice coil 12 wound around a cylindrical voice coil bobbin 11.

The magnetic circuit 3 includes a yoke 15 composed of a disk-shaped plate 15a and a cylindrical center pole 15b projected from the center thereof, a ring-shaped magnet 16 loosely fit on the outer periphery of the center pole 15b and a ring-shaped top plate 17 loosely fit on the tip side of the center pole 15b so as to sandwich the magnet 16 between itself and the plate 15a.

The gap between the inner periphery of the top plate 17 and the center pole 15b serves as a magnetic gap 19 where the voice coil 12 is arranged.

At the center of the diaphragm 9, an opening 9a through which the voice coil bobbin 11 is passed is formed. The edge 7 connected to the outer edge of the diaphragm 9 is secured to the edge supporting portion 5a in such a fashion that an attaching flange attached to the outer periphery of the edge 7 is sandwiched between a ring-shaped gasket 21 put on the edge supporting portion 5a and the edge supporting portion 5a. The inner edge of the diaphragm 9 which forms the opening 9a is secured to the outer periphery of the voice coil bobbin 11 passed through the opening 9a using, e.g., adhesive.

Further, a dust cap 23 is put on the center of the diaphragm 9. The dust cap 23 covers the front of the voice coil bobbin 11 to prevent invasion of dust into the magnetic gap 19.

The cylindrical voice coil bobbin 11 is loosely fit on the outer periphery of the center pole 15b so that it is axially movable. The cylindrical voice coil bobbin 11 is also elastically supported by the frame 5 through a damper 25 so that its axial movement is limited. The diaphragm 9 is vibrated by the reciprocating vibration of the voice coil bobbin 11 owing to an input signal to the voice coil 12, thus making acoustic reproduction.

The damper 25 is formed in a corrugation structure with convexities and concavities alternately arranged in a radial direction, and called a corrugation damper.

The outer edge of the damper 25 is secured to a damper supporting portion 5b of the frame 5 whereas the inner edge of the damper 25 is secured to the outer periphery of the voice coil bobbin 11. Thus, the radial displacement of the voice coil bobbin 11 is limited. In addition, when the diaphragm 9 is driven, the vibration energy is absorbed by deformation of the corrugation to control the vibration of the diaphragm 9.

Meanwhile, in recent years, with development in a large output of a speaker unit, as a high-rigidity and high-performance speaker-use diaphragm which can endure the large output, there has been proposed a speaker-use diaphragm manufactured by impregnating a woven cloth of aramid fiber with thermosetting resin and thereafter performing heat-molding so that the woven cloth is molded into a predetermined shape (e.g., cone shape or dome shape) (see, e.g., JP-A-2001-169387 and JP-A-11-285094).

FIGS. 2 and 3 show weaving structures of woven cloth used for the speaker-use diaphragm described above.

A woven cloth 31 shown in FIG. 2 has a general plane-weaving structure in which warps 32 and wefts 33 with equal thickness are alternately woven one by one, respectively.

A woven cloth 35 shown in FIG. 3 has a weaving structure called a ripstop weaving in which when thin warps 36 and thin wefts 37 are plane-woven, thick warps 38 and thick weft 39 are woven at regular intervals.

### SUMMARY OF THE INVENTION

Meanwhile, onto a speaker diaphragm in operation, vibrations at various frequencies are simultaneously applied so that the vibration at an essentially unnecessary resonance frequency also acts on the diaphragm. The vibration at such a resonance frequency can be eliminated by dispersing it by the ruggedness (concavities and convexities) on the surface of the diaphragm.

Thus, from the viewpoint of eliminating the vibration at the resonance frequency, it is desirable that the woven cloth which is a raw material of the speaker-use diaphragm has great ruggedness to some degree.

However, the simple plane-weaving structure, as shown in FIG. 2, has small ruggedness due to the weaving of warps and wefts. This gives rise to a problem of difficulty of eliminating the vibration at the resonance frequency through dispersion by the ruggedness, for example.

On the other hand, in the ripstop weaving as shown in FIG. 3, since the ruggedness is formed by mixture of thin and thick threads, the ruggedness on the cloth surface can be made larger than in the simple plane-weaving. Therefore the ripstop weaving is preferable for dispersion/elimination of the vibration at the resonance frequency.

However, in the ripstop weaving, since two kinds of threads having different thickness must be prepared for both the warps and wefts, these threads having different thickness must be woven with regular changes. This gives rise to a problem of deterioration of productivity, for example.

According to an aspect of the invention, there is provided a speaker-use diaphragm including a woven cloth being impregnated with thermosetting resin and heat-molded to have a predetermined shape, wherein the woven cloth has a weaving structure with a weaving pattern which partitions a succession of textures of plane-weaving by a preset polygonal geometrical pattern.

### BRIEF DESCRIPTION OF THE DRAWINGS

FIG. 1 is a sectional view showing the configuration of a speaker in the related art;

FIG. 2 is a view for explaining the weaving structure of a woven cloth of a speaker-use diaphragm used in the speaker shown in FIG. 1;

FIG. 3 is a view for explaining the weaving structure of another woven cloth in the related art;

FIG. 4 is a sectional view showing the configuration of a speaker according to an embodiment of this invention; and

FIG. 5 is a view for explaining the weaving structure of a woven cloth of the speaker-use diaphragm used in the speaker shown in FIG. 4.

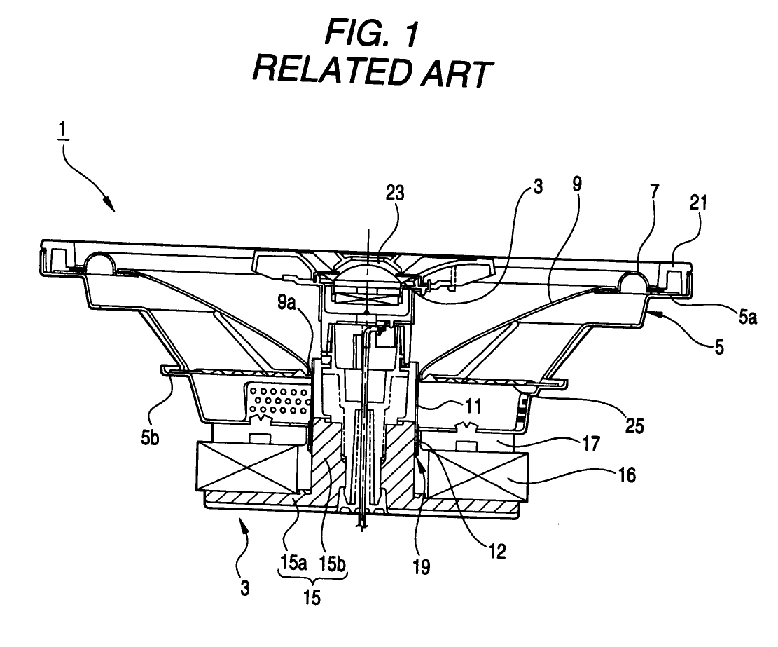

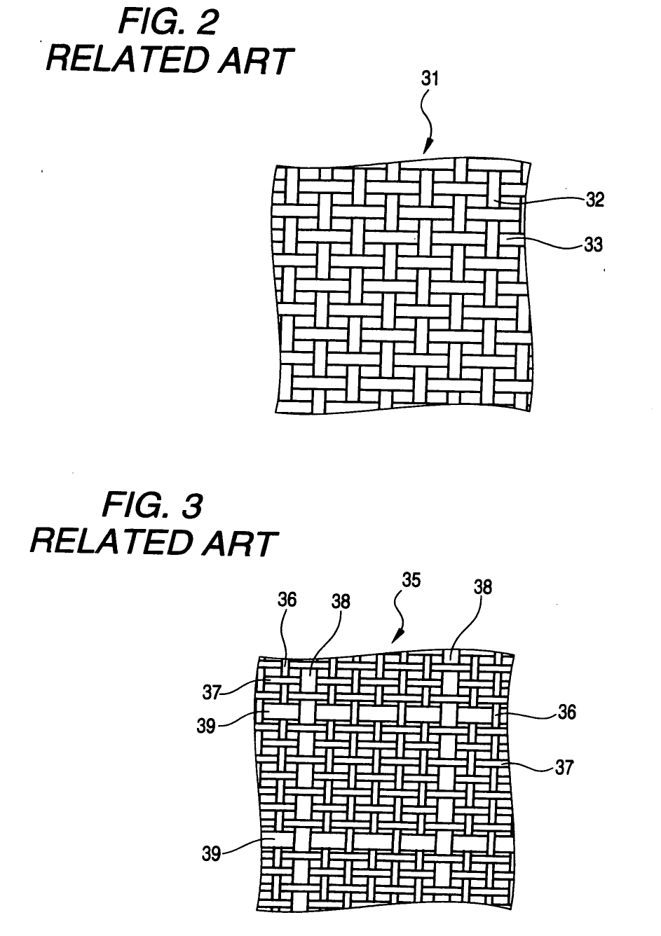

### DETAILED DESCRIPTION OF THE PREFFERED EMBODIMENTS

An explanation will be given of an embodiment of a speaker-use diaphragm and a speaker using the diaphragm according to this invention.

The invention provides a speaker-use diaphragm manufactured by impregnating a woven cloth with thermosetting resin and thereafter performing heat-molding so that the woven cloth is molded into a predetermined shape, wherein the woven cloth has a weaving structure with a weaving pattern which partitions a succession of textures of plane-weaving by a preset polygonal geometrical pattern.

The basic weaving of the woven cloth of fiber is plane-weaving in which threads with a unique thickness can be commonly used for the warps and wefts. Therefore, in a weaving step, it is not necessary to change the threads with different thickness regularly. This improves the productivity of the woven cloth.

Further, the woven cloth has the weaving pattern which partitions a succession of textures of plane-weaving by a preset polygonal geometrical pattern. Therefore the ruggedness is structured in two formats consisting of the ruggedness due to plane-woven parts and that due to the weaving pattern which partitions a succession of the textures of plane-weaving. Thus the ruggedness having a size efficient for dispersion/elimination of the vibration at the resonance frequency can be provided.

Preferably, the polygonal geometrical pattern is a pentagon or hexagon.

Insertion of the weaving pattern for partition by a heptagon or more polygonal geometrical pattern only makes the pattern complicate, and its effect is not displayed so greatly. Thus from the viewpoint of balance between manufacturing cost and operational effect, the pentagonal or hexagonal geometrical pattern is preferred.

Further, a speaker using the speaker-use diaphragm having the above configuration enables high-quality acoustic reproduction with suppressed noise occurrence due to the resonance.

Now referring to the drawings, a detailed explanation will be given of a speaker-use diaphragm and speaker according to an embodiment of this invention.

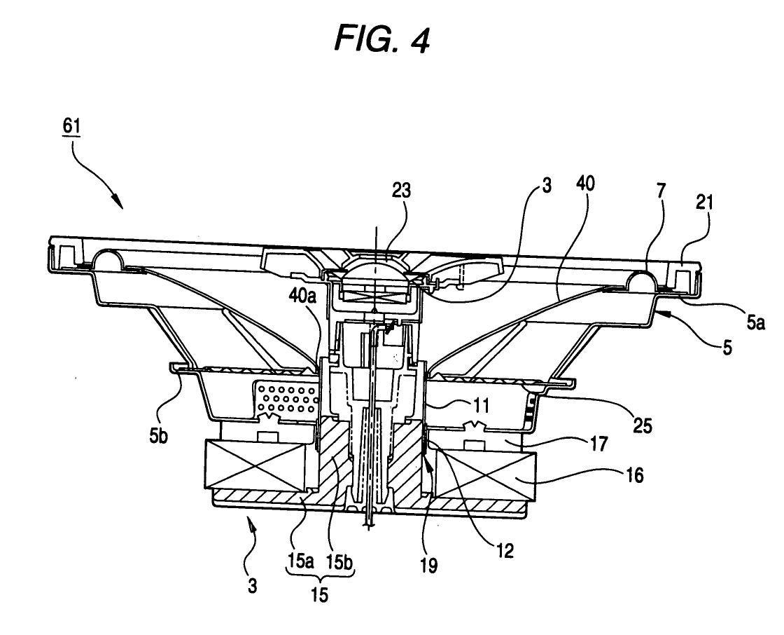

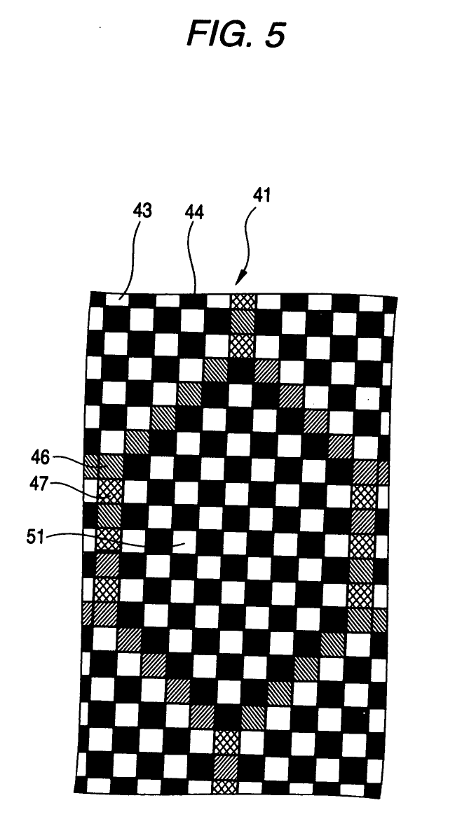

FIG. 4 is a sectional view showing the configuration of the speaker according to an embodiment of this invention. FIG. 5 is a plan view showing an embodiment of a weaving structure of the woven cloth used for the speaker-use diaphragm shown in FIG. 4.

A speaker 61 shown in FIG. 4 includes a magnetic circuit 3, a frame 5 to the rear of which the magnetic circuit 3 is attached, a cone-shaped diaphragm (speaker-use diaphragm) 40 in which a roll-shaped edge 7 on the outer edge is secured to an edge supporting portion 5a at the front of the frame 5 and a voice coil 12 wound around a cylindrical voice coil bobbin 11.

The magnetic circuit 3 includes a yoke 15 composed of a disk-shaped plate 15a and a cylindrical center pole 15b projected from the center thereof, a ring-shaped magnet 16 loosely fit on the outer periphery of the center pole 15b and a ring-shaped top plate 17 loosely fit on the tip side of the center pole 15b so as to sandwich the magnet 16 between itself and the plate 15a.

The gap between the inner periphery of the top plate 17 and the center pole 15b serves as a magnetic gap 19 where the voice coil 12 is arranged.

At the center of the diaphragm 40, an opening 40a through which the voice coil bobbin 11 is passed is formed. The edge 7 connected to the outer edge of the diaphragm 40 is secured to an edge supporting portion 5a in such a fashion that an attaching flange attached to the outer periphery of the edge 7 is sandwiched between a ring-shaped gasket 21 put on the edge supporting portion 5a and the edge supporting portion 5a. The inner edge of the diaphragm 40 which forms the opening 40a is secured to the outer periphery of the voice coil bobbin 11 passed through the opening 40a using, e.g., adhesive.

Further, a dust cap 23 is put on the center of the diaphragm 40. The dust cap 23 covers the front of the voice coil bobbin 11 to prevent invasion of dust into the magnetic gap 19.

The cylindrical voice coil bobbin 11 is loosely fit on the outer periphery of the center pole 15b so that it is axially movable. The cylindrical voice coil bobbin 11 is also elastically supported by the frame 5 through a damper 25 so that its axial movement is limited. The diaphragm 40 is vibrated by the reciprocating vibration of the voice coil bobbin 11 owing to an input signal to the voice coil 12, thus making acoustic reproduction.

The outer edge of the damper 25 is secured to a damper supporting portion 5b of the frame 5 whereas the inner edge of the damper 25 is secured to the outer periphery of the voice coil bobbin 11. Thus, the radial displacement of the voice coil bobbin 11 is limited. In addition, when the diaphragm 40 is driven, the vibration energy is absorbed by deformation of the corrugation to control the vibration of the diaphragm 40.

The diaphragm 40 according to this embodiment is manufactured by impregnating a woven cloth 41 with thermosetting resin and thereafter heat-molding the woven cloth 41 sandwiched in a predetermined die at a predetermined temperature so that it is molded into a cone shape. The diaphragm 40 according to this embodiment is characterized by the weaving structure of the woven cloth 41 of fiber such as aramid fiber.

The cloth 41 shown in FIG. 5 is basically made by plane-weaving in which threads with an unique thickness are alternately woven one by one for both warps and wefts.

However, the cloth 41 has a weaving structure with a weaving pattern which partitions the range of successive textures of plane-weaving (range of successive checkered patterns in FIG. 5) by a preset hexagonal geometrical pattern.

In FIG. 5, white squares 43 and black squares 44 exhibit the textures by general plane-weaving. Diagonal-hatched squares 46 and cross-hatched squares 47 exhibit textures (hereinafter referred to as partitions) which partition a succession of the textures 43, 44 of plane-weaving.

In this embodiment, the partitions 46, 47 form a weaving pattern which partitions a succession of checkered patterns of plane weaving by a hexagonal geometrical pattern (In FIG. 5, the outer peripheral shape of the range 51 of the successive checkered patterns is the hexagon).

In the diaphragm 40 formed of the woven cloth 41 according to this embodiment, the basic weaving of the woven cloth of fiber such as aramid fiber is plane-weaving in which threads with a unique thickness can be commonly used for the warps and wefts. Therefore, in the weaving step, it is not necessary to change the threads with different thickness regularly. This improves the productivity of the woven cloth 41.

Further, the woven cloth has the weaving pattern which partitions a succession of textures 43, 44 of plane-weaving by a preset hexagonal polygonal geometrical pattern. Therefore the ruggedness is structured in two formats consisting of the ruggedness due to plane-woven parts and that due to the weaving pattern which partitions a succession of the textures 43, 44 of plane-weaving. Thus the ruggedness having a size efficient for dispersion/elimination of the vibration at the resonance frequency can be provided.

As a result, the speaker 61 using the speaker-use diaphragm 40 having the above configuration enables high-quality acoustic reproduction with suppressed noise occurrence due to the resonance.

Additionally, the speaker-use diaphragm and the fiber, woven cloth and speaker-use diaphragm in the speaker according to this invention should not be limited to those in the embodiments described above. They may be realized in various forms on the basis of the spirit of this invention.

For example, the embodiment described above adopts the weaving pattern which partitions a succession of checkered patterns by a hexagonal geometrical pattern consisting of the partitions 46, 47. However, the weaving pattern which partitions a succession of checkered patterns by the partitions 46, 47 should not be limited to the weaving pattern described above.

The succession of the checkered patterns by plane-weaving may be partitioned by a pentagonal geometrical pattern, and further by a heptagon or more polygonal geometrical pattern. However, insertion of the weaving pattern for partition by a heptagon or more polygonal geometrical pattern only makes the pattern complicate, and its effect is not displayed so greatly. Thus from the viewpoint of balance between manufacturing cost and operational effect, the pentagonal or hexagonal geometrical pattern is preferred.

The woven cloth according to this invention is composed of twisted threads of the fiber such as aramid fiber for the warps and wefts to be woven. The fiber may be meta-aramid fiber or para-aramid fiber.

A typical example of the meta-aramid fiber is polymetaphenylene isophthal amide.

A typical example of the para-aramid fiber is an aromatic polyamide fiber such as coparaphenylene-3, 4′-oxydiphenylenetelephthalamide or PPTA (polyphenylenetelephthalamide).

Incidentally, the fiber of the woven cloth for the speaker-use diaphragm according to this invention should not be limited to the aramid fiber described above, but may be carbon fiber, PBO (polyparaphenylene-benzobis-oxazole, glass fiber, PET (polyethylene-terephthalate) fiber, PEN (polyethylene naphthalate), etc. Further, in the embodiments described above, the explanation was given of the molding method of manufacturing the speaker-use diaphragm by impregnating the woven cloth with thermosetting resin to provide a prepreg and thereafter molding the prepreg into a predetermined shape by heating/cooling. However, this invention should not be limited to such a molding method. The speaker-use diaphragm can be manufactured by the molding method of injecting the thermosetting resin into a molding die in which the woven cloth is set so that the woven cloth is molded into a predetermined shape simultaneously with the injection molding.

1. A speaker-use diaphragm, comprising:
a woven cloth being impregnated with thermosetting resin and heat-molded to have a predetermined shape,
wherein the woven cloth has a weaving structure with a weaving pattern which partitions a succession of textures of plane-weaving by a preset polygonal geometrical pattern.

2. The speaker-use diaphragm according to claim 1, wherein the polygonal geometrical pattern is a pentagon or hexagon.

3. A speaker, comprising:
a diaphragm including a woven cloth being impregnated with thermosetting resin and heat-molded to have a predetermined shape,
wherein the woven cloth has a weaving structure with a weaving pattern which partitions a succession of textures of plane-weaving by a preset polygonal geometrical pattern.
